(19) United States
(12) Patent Application Publication
(10) Pub. No.: US 2024/0256838 A1
(43) Pub. Date: Aug. 1, 2024

(54) APPARATUS, METHOD, DEVICE AND MEDIUM FOR ACCELERATING COMPUTATION OF PROCESS ENGINE

(71) Applicant: Intel Corporation, Santa Clara, CA (US)

(72) Inventors: Xu QIAN, Shanghai (CN); Haiyun HONG, Shanghai (CN); Peiqing JIANG, Shanghai (CN); Yuanyuan LI, Shanghai (CN); Sijia LOU, Shanghai (CN)

(21) Appl. No.: 18/565,996

(22) PCT Filed: Nov. 25, 2021
(86) PCT No.: PCT/CN2021/133099

§ 371 Date: Nov. 30, 2023

(51) Int. Cl. G06N 3/0464

(52) U.S. Cl. CPC G06N 3/0464

(57) ABSTRACT

An apparatus, method, device, and medium for accelerating computation of a process engine are provided. The apparatus includes interface circuitry configured to receive weight data and activation data stored in a batch-height-width-channel (NHWC) memory layout; and processor circuitry configured to in response to that a input channel size is not an integer multiple of a process capacity of a process engine, pad a number of zeroes after a last element of weight data belonging to a filter and a last element of corresponding activation data respectively, slice all weight data elements belonging to the filter and padded zeroes into weight data slices, and corresponding activation data elements and padded zeroes into corresponding activation data slices, in a scale of the process capacity, and feed the process engine with each weight data slice and a corresponding activation data slice sequentially.

### TECHNICAL FIELD

Embodiments of the present disclosure generally relate to techniques of neural networks, and in particular to an apparatus, method, device, and medium for accelerating computation of a process engine.

### BACKGROUND ART

In a neural network acceleration architecture, there are a lot of process engines, in each of which, an inner product or convolution of matrixes/tensors may be computed. Input channels of different tasks may vary a lot and thus the number of the input channels are not necessarily an integer multiple of a process capacity of the process engine. In neural network acceleration hardware, most of circuits and areas are allocated for the process engines, which usually require data of fixed lengths. However, a process engine might be underutilized when an input channel size (i.e., the number of input channels) is not an integer multiple of the process capacity of the process engine. Currently, the input channels need to be padded to fit in the process engine. As a result, a memory utilization ratio is reduced and computation of the process engine is slowed down.

### SUMMARY

According to an aspect of the disclosure, an apparatus is provided. The apparatus includes interface circuitry configured to receive weight data and activation data, wherein the weight data and the activation data are stored in a batch-height-width-channel (NHWC) memory layout; and processor circuitry coupled to the interface circuitry and configured to: determine a process capacity of a process engine; determine an input channel size; in response to that the input channel size is not an integer multiple of the process capacity, pad a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine, slice all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and feed the process engine with each weight data slice and a corresponding activation data slice sequentially.

According to another aspect of the disclosure, a method is provided. The method includes determining a process capacity of a process engine; determining an input channel size; in response to that the input channel size is not an integer multiple of the process capacity, padding a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine, wherein the weight data and the corresponding activation data are stored in a batch-height-width-channel (NHWC) memory layout, slicing all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and feeding the process engine with a weight data slice and a corresponding activation data slice sequentially.

Another aspect of the disclosure provides a device including means for implementing the method of the disclosure.

Another aspect of the disclosure provides a machine readable storage medium having instructions stored thereon, which when executed by a machine cause the machine to perform the method of the disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows an exemplary batch-height-width-channel (NHWC) layout of a 1×4×4×8 activation tensor in a memory, in accordance with some embodiments of the disclosure.

FIG. 2 shows an exemplary NHWC layout of a 2×3×3×8 weight tensor in a memory, in accordance with some embodiments of the disclosure.

FIG. 3 shows a schematic diagram of a traditional way to calculate an inner product of the activation tensor of FIG. 1 and the weight tensor of FIG. 2 using a process engine having a process capacity of 16.

FIG. 4 shows a schematic diagram of a proposed solution to calculate an inner product of the activation tensor of FIG. 1 and the weight tensor of FIG. 2 using a process engine having a process capacity of 16, in accordance with some embodiments of the disclosure.

FIG. 5 shows a flow chart showing a process 500 for accelerating computation of a process engine in accordance with some embodiments of the disclosure.

FIG. 6 is an illustrative diagram showing a graph of acceleration of the proposed solution versus the traditional way of padding zeroes after each data group over different input channel sizes and under different kernel sizes.

FIG. 7 is a block diagram illustrating components, according to some example embodiments, able to read instructions from a machine-readable or computer-readable medium and perform any one or more of the methodologies discussed herein.

FIG. 8 is a block diagram of an example processor platform in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

In a deep learning framework, data generally have four dimensions (4D), which may be expressed as a tensor. There are two typical memory layouts, i.e., NCHW and NHWC layouts, supported by modern deep learning hardware and software, where N means the number of batch(es), C means the number of input channels (which is defined as an “input channel size” herein), H means a height of the tensor, and W means a width of the tensor.

Embodiments of the present disclosure propose solutions to accelerate computation (such as inference) of a process engine based on the widely sued NHWC layout. For example, in the visual processing unit (VPU), Keem Bay, of Intel Corporation, the NHWC layout is used for most layers.

In general, for the NHWC layout, a memory offset is computed based on an equation (1) as follows:

$$offset\_nhwc ( n , c , h , w ) = n * HWC + h * WC + w * C + c \qquad ( 1 )$$

where N, H, W, C are given by the tensor itself, n=0, 1, . . . , n−1, h=0, 1, . . . , h−1, w=0, 1, . . . , w−1, and c=0, 1, . . . , c−1.

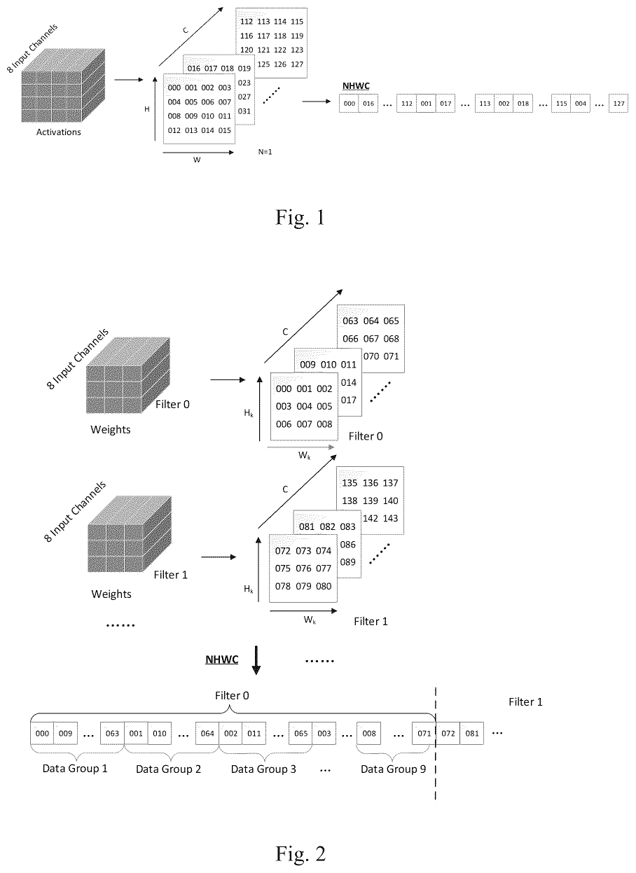

FIG. 1 shows an exemplary NHWC layout of a 1×4×4×8 activation tensor in a memory, in accordance with some embodiments of the disclosure. For the 1×4×4×8 tensor, N=1, H=4, W=4, and C=8. In the NHWC layout, the inner-most dimension is an input channel size (i.e., C), which is followed by a width (i.e., W) and height (i.e., H) of the tensor, and finally a batch size (i.e., N).

As shown in FIG. 1, according to the NHWC layout, the first element with an index 000 of the first channel, when stored in the memory, is followed by an element with an index 016, which is the first element of the next channel; an element after the first element of the last channel with an index 112, as stored in the memory, is the second element with an index 001 of the first channel; and so on.

FIG. 2 shows an exemplary NHWC layout of a 2×3×3×8 weight tensor in a memory, in accordance with some embodiments of the disclosure. For the 2×3×3×8 tensor, N=2, H=3, W=3, and C=8. For the weight tensor, N means the number of filters, H and W mean a kernel height and a kernel width of a filter, and C means the number of input channels.

As shown in FIG. 2, according to the NHWC layout, for the first filter (filter 0), the first element with an index 000 of the first channel, when stored in the memory, is followed by an element with an index 009, which is the first element of the next channel; an element after the first element of the last channel with an index 063, as stored in the memory, is the second element with an index 001 of the first channel; and so on. The last element of the first filter, as stored in the memory, has an index of 071. Elements of the second filter are stored after the last element of the first filter, in the same sequence as the elements of the first filter.

In embodiments of the disclosure, the activation tensor and the weight tensor may be stored in the same memory or different memories. The term “memory”, as used herein, may include one or more physical apparatus used to store data or programs on a temporary or permanent basis. In some embodiments, the memory may include one or more of a dynamic random-access memory (DRAM), a ferroelectric random access memory (FRAM), a phase-change random access memory (PRAM), a read-only memory (ROM), a random access memory (RAM), a digital video disk (DVD), a flash memory, a magnetic disk, a magnetic tape drive, optical disk drive, a cloud computing based storage, among others.

In embodiments of the disclosure, Movidius™ Keem Bay of Intel© is taken as an example to illustrate the concept of the application. In the third-generation hardware of Movidius™ Keem Bay, the process engine is used to calculate an inner product of 16 operands in one cycle. Therefore, the input channel size needs to be padded to an integer multiple of 16 before sending to the process engine. It is to be noted that the principle of the present application can be generalized to other neural network acceleration hardware where the input channel size need to fit in a certain process capacity of the process engine.

In the Keem Bay example, the process engine is capable to process 16 operands at a time. That is to say, a process capacity of the process engine is 16. In other examples, the process capacity of the process engine may be 32, 64, 128, 256, 512, 1024, and so on.

For example, the process engine having the process capacity of 16 may be used to calculate an inner product of the activation tensor of FIG. 1 and the weight tensor of FIG. 2. Traditionally, the input channel size need to be padded to 16, for example, with zeroes, so as to be an integer multiple of the process capacity of the process engine. As another example, when an input channel size is 24, the input channel size need to be padded to 32, to be 2 multiples of the process capacity of the process engine.

Just for simplicity and clarity of description, a phrase “data group” is defined herein. For the weight tensor as shown in FIG. 2, the first element of each input channel is defined to belong to a first data group, the second element of each input channel is defined to belong to a second data group, the third element of each input channel is defined to belong to a third data group, . . . , and the ninth element of each input channel is defined to belong to a ninth data group. It should be noted that the “data groups” do not exist actually, all the data elements are stored in the memory continuously, as in the well-known NHWC memory layout.

For the activation data of FIG. 1, for example, when an inner product of the activation tensor of FIG. 1 and the weight tensor of FIG. 2 is calculated in the process engine, activation data elements multiplied with the weight data elements of the first data group of the activation tensor may be called a first data group of the activation tensor, activation data elements multiplied with the weight data elements of the second data group of the activation tensor may be called a second data group of the activation tensor, . . . , and activation data elements multiplied with the weight data elements of a ninth data group of the activation tensor may be called the ninth data group of the activation tensor. As known, when the inner product of the activation tensor and the weight tensor is calculated, the weight tensor will shifted to perform the inner product operation with different parts of the weight tensor. Therefore, for each inner product operation, the data groups of the activation tensor corresponding to the weight groups of the activation tensor are different.

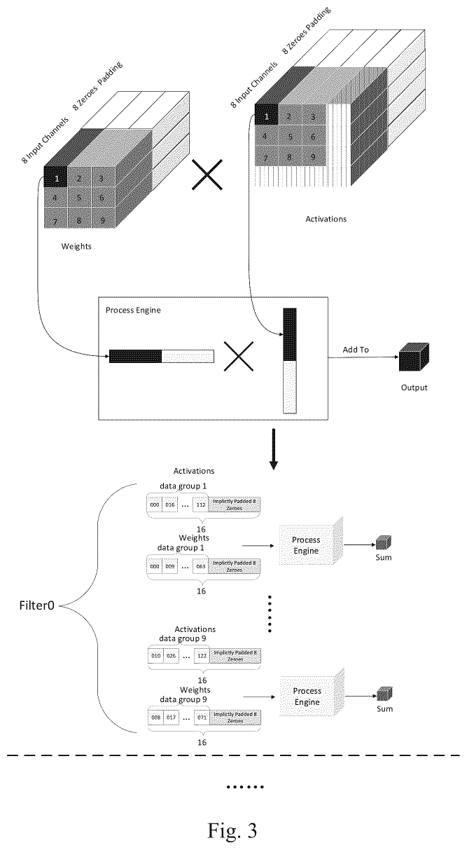

FIG. 3 shows a schematic diagram of a traditional way to calculate the inner product of the activation tensor of FIG. 1 and the weight tensor of FIG. 2 using the process engine having the process capacity of 16.

As shown, each data group (numbered as 1, 2, . . . , 9 in FIG. 3) of the weight data and a corresponding data group (numbered as 1, 2, . . . , 9 correspondingly in FIG. 3) of the activation data are padded with eight zeroes, respectively, to round up the input channel size to be the same as the process capacity of the process engine (i.e., 1 multiple of the process capacity of the process engine in this case).

As a result, the traditional way would lead to a great waste of computation. For the traditional way,

$$a memory utilization rate = \frac{C\_size / PE\_capacity}{⌈ C\_size / PE\_capacity ⌉} ,$$

wherein C_size represents the input channel size, PE_capacity represents the process capacity of the process engine, and ┌⋅┐ means rounding up. For example, in the case of FIG. 3, the memory utilization rate is 8/16=50%, because the padded 8 zeroes will take up computation resources but has no contribute to the final output. That is to say, a computational efficiency is low, when the input channel size (i.e., the number of input channels. e.g., 8) is not an integer multiple of the process capacity of the process engine (e.g., 16).

This problem does not only exist in Artificial intelligence (AI) Application-specific integrated circuits (ASICs) but also in central processing unit (CPU) instructions, such as AVX-512 Vector Neural Network Instructions (AVX512 VNNI). In VPDPBUSD instructions, inner products are calculated per 4 elements. So, the input channels need to be padded to the multiplier of 4 before using VPDPBUSD to calculate the inner product. For example, the AVX512-VNNI is introduced in the Cascade Lake and Ice Lake for accelerating integer 8 (Int8) convolution operations. The VPDPBUSD instructions calculate inner products of 4-elements at the same time. Therefore, the input channels need to be padded to an integer multiple of 4 before using the VPDPBUSD instructions to calculate the inner products. But not all layers have 4-aligned channels. For computer vision tasks, inputs to the first convolution layer usually have 3 channels, and thus one channel of zeroes needs to be padded in the end of the 3 channels. This would result in a waste of ¼ computation.

In order to solve at least some of the above-mentioned problems, embodiments of the disclosure provide solutions to improve memory utilization and accelerate computation of a process engine, based on the widely used NHWC memory layout.

Based on the NHWC memory layout, the data groups (as defined above) belonging to the same filter can calculate together without changing the output value. Therefore, data from different data groups belonging to the same filter may be combined to fit the process capacity of the process engine in computation.

Further referring to the activation tensor of FIG. 1 and the weight tensor of FIG. 2, when an inner product of the activation tensor and the weight tensor is computed, weight data elements from different data groups belonging to the same filter and corresponding activation data elements may be combined respectively, to fit the process capacity of the process engine.

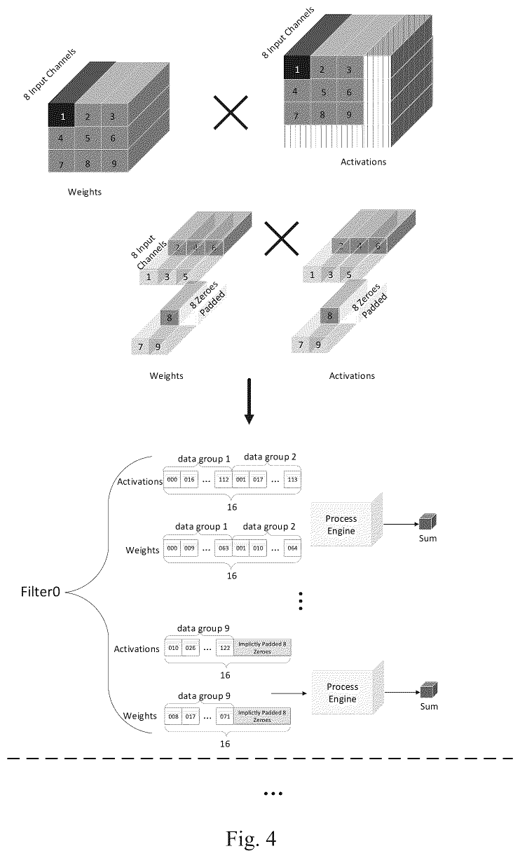

FIG. 4 shows a schematic diagram of a proposed solution to calculate the inner product of the activation tensor of FIG. 1 and the weight tensor of FIG. 2 using the process engine having the process capacity of 16, in accordance with some embodiments of the disclosure.

Similarly as in FIG. 3, the data groups of the weight data are numbered as 1, 2, . . . , 9, and corresponding data groups of the activation data are also numbered as 1, 2, . . . , 9. Each data group of the weight data has eight weight data elements, and each data group of the activation data has eight activation data elements, since the input channel size is 8. In this solution, weight data elements of the data group 1 and data group 2 of the weight data can be combined to form a first weight data slice having 16 weight data elements, and correspondingly, activation data elements of the data group 1 and data group 2 of the activation data can be combined to form a first activation data slice having 16 activation data elements; the first weight data slice having 16 weight data elements and the first activation data slice having 16 activation data elements are then feed to the process engine having the process capacity of 16; and the inner product operation of the first one-dimensional vector having 16 weight data elements and the first activation data slice having 16 activation data elements may be performed to obtain a first sum. similarly, weight data elements of the data group 3 and data group 4 of the weight data can be combined to form a second weight data slice having 16 weight data elements, and correspondingly, activation data elements of the data group 3 and data group 4 of the activation data can be combined to form a second activation data slice having 16 activation data elements; the second weight data slice having 16 weight data elements and the second activation data slice having 16 activation data elements are then feed to the process engine having the process capacity of 16; and the inner product operation of the second weight data slice having 16 weight data elements and the second activation data slice having 16 activation data elements may be performed to obtain a second sum. Continuously, similar operations can be performed on weight data elements of data groups 5 and 6 and corresponding activation data elements of data group 5 and 6 to obtain a third sum, weight data elements of data groups 7 and 8 and corresponding activation data elements of data group 7 and 8 to obtain a fourth sum.

When it comes to the data group 9 of the weight data and the corresponding data group 9 of the activation data, there is no following data group on the same filter. In order to fit the process capacity of the process engine, 8 zeroes can be added after data group 9 of the weight data, i.e., after the last weight data element belonging to the filter 0, to form a fifth weight data slice having 16 elements, and correspondingly, 8 zeroes can be added after data group 9 of the activation data to form a fifth activation data slice having 16 elements. The fifth weight data slice and the fifth activation data slice are then feed to the process engine having the process capacity of 16. The inner product operation of the fifth weight data slice and the fifth activation data slice may be performed to obtain a fifth sum.

The first to the fifth sums may then be added up to obtain a final output.

The operations for calculation with the other filter(s) are the similar as those described above, which will not be detailed herein.

According to the proposed solution, a memory utilization

$$ratio = \frac{C\_size \times {W}_{k} \times {H}_{k} / PE\_capacity}{⌈ C\_size \times {W}_{k} \times {H}_{k} / PE\_capacity ⌉} ,$$

where C_size represents the input channel size, Wₖ represents the kernel width of the filter, Hₖ represents the kernel height of the filter, PE_capacity represents the process capacity of the process engine, and ┌⋅┐ means rounding up. Therefore, in the case of FIG. 4, the memory utilization ratio is 90%. As compared with the memory utilization ratio of 50% of the traditional way as described in FIG. 3, the computation is accelerated by 90%/50%=1.8

FIG. 1 to FIG. 4 use the particular examples to illustrate the principles of the application “visually”. Actually, the principles of the application can be generalized to various neural network acceleration hardware where an input channel size need to fit in a certain process capacity of a process engine.

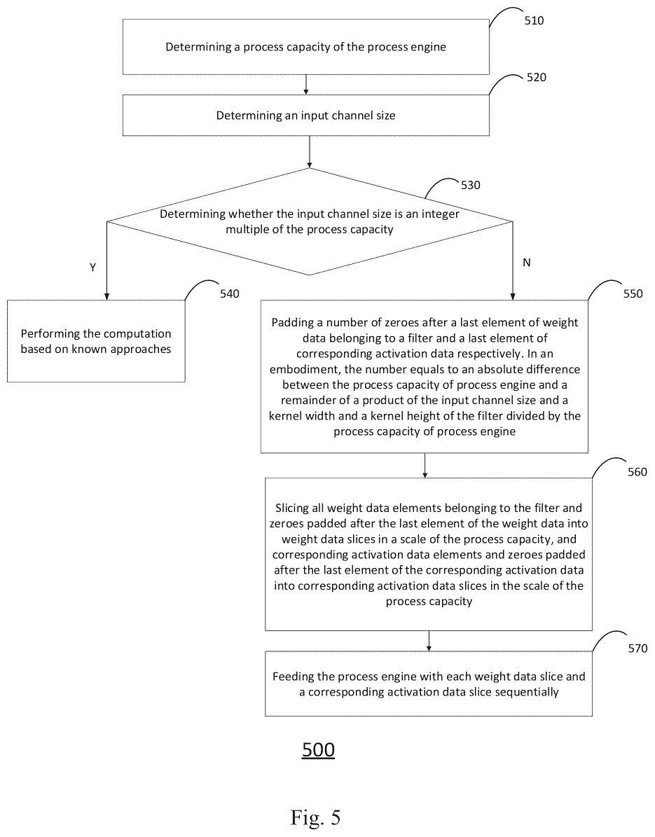

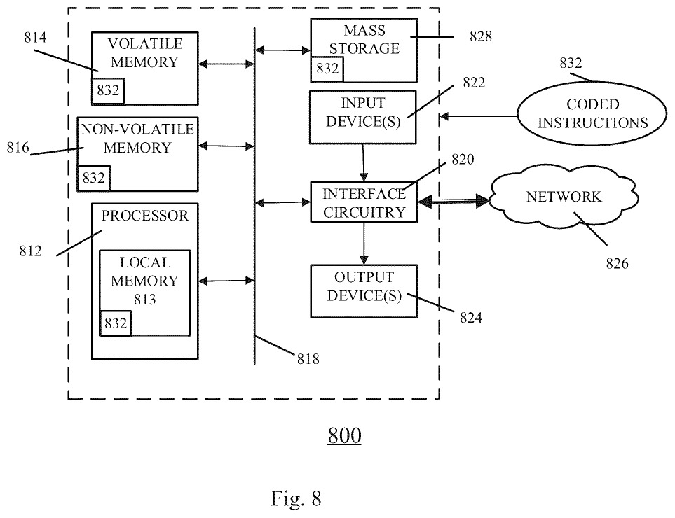

FIG. 5 shows a flow chart showing a process 500 for accelerating computation of a process engine in accordance with some embodiments of the disclosure. The process 500 may be implemented, for example, by one or more processors of a neural network acceleration architecture. An example of the processors is to be shown in FIG. 8.

As mentioned above, both weight data and activation data, for which the computation to be performed on, are stored in the NHWC layout in one or more memories.

The process 500 may include, at block 510, determining a process capacity of the process engine. In examples, the process capacity of the process engine may be 4, 8, 16, 32, 64, 128, 256, 512, 1024, and so on.

The process 500 may include, at block 520, determining an input channel size, i.e., the number of input channels.

The process 500 may include, at block 530, determining whether the input channel size is an integer multiple of the process capacity.

If the input channel size is an integer multiple of the process capacity, the process 500 proceeds to block 540 to perform the computation based on known approaches.

If the input channel size is not an integer multiple of the process capacity, the process 500 proceeds to block 550 to block 550 to pad a number of zeroes after a last element of weight data belonging to a filter and a last element of corresponding activation data respectively. In an embodiment, the number equals to an absolute difference between the process capacity of process engine and a remainder of a product of the input channel size and a kernel width and a kernel height of the filter divided by the process capacity of process engine, i.e.,

$$\vert {PE}_{capacity} - \{ {C}_{size} \times {W}_{k} \times {H}_{k} - [ ( {C}_{size} \times {W}_{k} \times {H}_{k} ) mod {PE}_{capacity} ] \times {PE}_{capacity} \} \vert ,$$

where C_size represents the input channel size, Wₖ represents the kernel width of the filter, Hₖ represents the kernel height of the filter, PE_capacity represents the process capacity of the process engine. For example, in the example of FIG. 4, the number=|16−{8×3×3−[(8×3×3) mod 16]×16}|=8. The weight data are stored in the NHWC layout in a first memory and the corresponding activation data are stored in the NHWC layout in a second memory.

The process 500 then proceeds to block 560 to slice all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity.

It is to be noted that the slicing operation at block 560 is implicitly performed in real computation instances, but it is described explicitly herein for purpose of illustrating the principle of the application. That is to say, the weight data elements and corresponding activation data elements are not sliced actually, but stored in the memory in the well-known NHWC layout without any extra overhead.

The process 500 then proceeds to block 570 to feed the process engine with each weight data slice and a corresponding activation data slice sequentially.

The process 500 may be repeated for each filter.

According to the process 500, a memory utilization

$$ratio = \frac{C\_size \times {W}_{k} \times {H}_{k} / PE\_capacity}{⌈ C\_size \times {W}_{k} \times {H}_{k} / PE\_capacity ⌉} ,$$

where C_size represents the input channel size, Wₖ represents the kernel width of the filter, Hₖ represents the kernel height of the filter, PE_capacity represents the process capacity of the process engine, and ┌⋅┐ means rounding up. Therefore, in the case of FIG. 4, the memory utilization ratio is 90%. As compared with the memory utilization ratio of 50% of the traditional way as described in FIG. 3, the computation is accelerated by 90%/50%=1.8

As another example of applying the process 500, weight data of a 2×3×3×24 weight tensor are stored in a first memory in the NHWC layout, and activation data of a 1×4×4×24 activation tensor are stored in a second memory in the NHWC layout. The first memory and the second memory may be the same or not. Computation is to be performed on the 2×3×3×24 weight tensor and 1×4×4×24 activation tensor by a process engine having a process capacity of 16. Based on the definition of “data group”, weight data of each filter includes 9 data groups, and activation data corresponding to the weight data of each filter also includes 9 data groups.

At block 510, a process capacity of the process engine is determined, which is 16.

At block 520, an input channel size is determined which is 24.

At block 530, it is determined that the input channel size is not an integer multiple of the process capacity, since 24/16=1.5.

At block 550, a number of zeroes are padded after a last element of weight data belonging to a filter and a last element of corresponding activation data respectively. The number=|16−{24×3×3−[(24×3×3) mod 16]×16}|=8.

At block 570, the process engine is fed with first 16 weight data elements from a first data group and corresponding activation data elements in a first computation cycle, remaining 8 weight data elements from the first data group and first 8 weight data elements from a second data group and corresponding activation data elements in a second computation cycle, remaining 16 weight data elements from the second data group and corresponding activation data elements in a third computation cycle, first 16 weight data elements from a third data group and corresponding activation data elements in a fourth computation cycle, remaining 8 weight data elements from the third data group and first 8 weight data elements from a fourth data group and corresponding activation data elements in a fifth computation cycle, remaining 16 weight data elements from the fourth data group and corresponding activation data elements in a sixth computation cycle, first 16 weight data elements from a fifth data group and corresponding activation data elements in a seventh computation cycle, remaining 8 weight data elements from the fifth data group and first 8 weight data elements from a sixth data group and corresponding activation data elements in a eighth computation cycle, remaining 16 weight data elements from the sixth data group and corresponding activation data elements in a ninth computation cycle, first 16 weight data elements from a seventh data group and corresponding activation data elements in a tenth computation cycle, remaining 8 weight data elements from the seventh data group and first 8 weight data elements from a eighth data group and corresponding activation data elements in a eleventh computation cycle, remaining 16 weight data elements from the eighth data group and corresponding activation data elements in a twelfth computation cycle, first 16 weight data elements from a ninth data group and corresponding activation data elements in a thirteenth computation cycle.

The process engine is then fed with the remaining 8 weight data elements from the ninth data group with 8 zeroes padded thereafter and corresponding activation data elements with 8 zeroes padded thereafter in a fourteenth computation cycle.

The above operations are also to be performed for the other filter.

In this case, the memory utilization

$$ratio = \frac{24 \times 3 \times 3 / 16}{⌈ 24 \times 3 \times 3 / 16 ⌉} \approx 96.42 \% .$$

As compared with the memory utilization ratio of 75%

$$( i . e . , \frac{24 / 16}{⌈ 24 / 16 ⌉} )$$

of the traditional way, the computation is accelerated approximately 1.286.

More particularly, the process 500 of FIG. 5 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the process 500 of FIG. 5 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

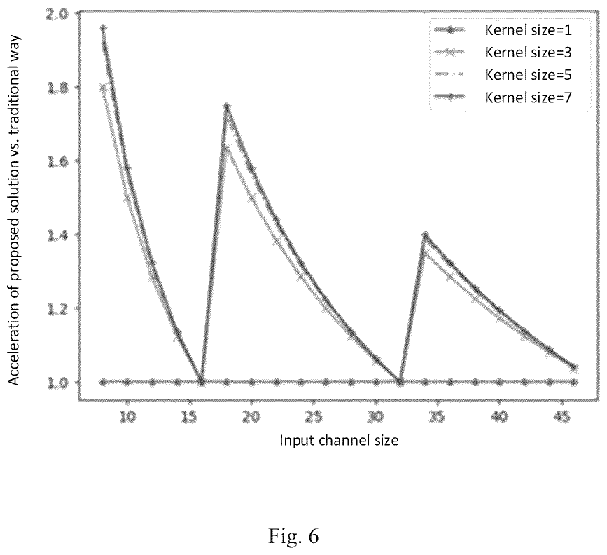

To be more generally, FIG. 6 is an illustrative diagram showing a graph of acceleration of the proposed solution versus the traditional way of padding zeroes after each data group over different input channel sizes and under different kernel sizes.

As shown in FIG. 6, the acceleration of the proposed solution is greater than 1 for various input channel sizes and kernel sizes. Particularly, when the kernel size is 1, the acceleration is also 1, i.e., no acceleration. This is because different data groups belong to different filters and the inner product cannot be added together in this case.

The proposed solution has been applied to a widely used super resolution network e.g., a Fast Super-Resolution Convolutional Neural Network (FSRCNN), to verify the acceleration of computation. Table 1 below shows flops of different convolution layers (abbreviated as “Conv”) of the FSRCNN.

TABLE 1

| | | | | Input | | Flops with | Flops with | |
|---|---|---|---|---|---|---|---|---|
| | | N of | Filter | feature | Original | original | proposed | Acceleration |
| FSRCNN | Layout | filters | size | map | flops | padding | padding | ratio |
| Conv1 | NCHW | 56 | 5 × 5 × 1 | 100 × 100 | 1.40E+07 | 1.40E+07 | 1.40E+07 | 1 |
| Conv2 | NHWC | 12 | 1 × 1 × 56 | 100 × 100 | 6.72E+06 | 7.68E+06 | 7.68E+06 | 1 |
| Conv3 | NHWC | 12 | 3 × 3 × 12 | 100 × 100 | 1.30E+07 | 1.73E+07 | 1.34E+07 | 1.28571429 |
| Conv4 | NHWC | 12 | 3 × 3 × 12 | 100 × 100 | 1.30E+07 | 1.73E+07 | 1.34E+07 | 1.28571429 |
| Conv5 | NHWC | 12 | 3 × 3 × 12 | 100 × 100 | 1.30E+07 | 1.73E+07 | 1.34E+07 | 1.28571429 |
| Conv6 | NHWC | 56 | 1 × 1 × 12 | 100 × 100 | 6.72E+06 | 8.96E+06 | 8.96E+06 | 1 |
| Conv7 | NHWC | 16 | 1 × 1 × 56 | 100 × 100 | 8.96E+06 | 1.02E+07 | 1.02E+07 | 1 |
| Total | NA | NA | NA | NA | 7.53E+07 | 9.27E+07 | 8.12E+07 | 1.14187192 |

As shown in Table 1, the Conv3, Conv4 and Conv5 layer of the FSRCNN all have an input channel size of 12. As a result, originally, 4 zeroes need to be padded for a process engine that takes 16 operands at a time to process. Based on the proposed solution, 16 data elements continuously stored in a memory and corresponding activation data elements may be taken at a time. 4 zeroes may be padded after a last weight data element belonging to the filter and a corresponding last activation data element respectively. This will result in

$$acceleration = \frac{12 \times 3 \times 3 / 16}{⌈ 12 \times 3 \times 3 / 16 ⌉} / \frac{12 / 16}{⌈ 12 / 16 ⌉} \approx 1.286 ,$$

due to decrease of computation.

For Conv2, Conv6 and Conv7, the kernel height and width are 1, so there is only one data group of weights per filter. Thus, there is no acceleration.

For Con1, the proposed solution is not applicable, since it uses the NCHW memory layout.

In conclusion, the overall acceleration is 1.14 for the FSRCNN after using the proposed solution.

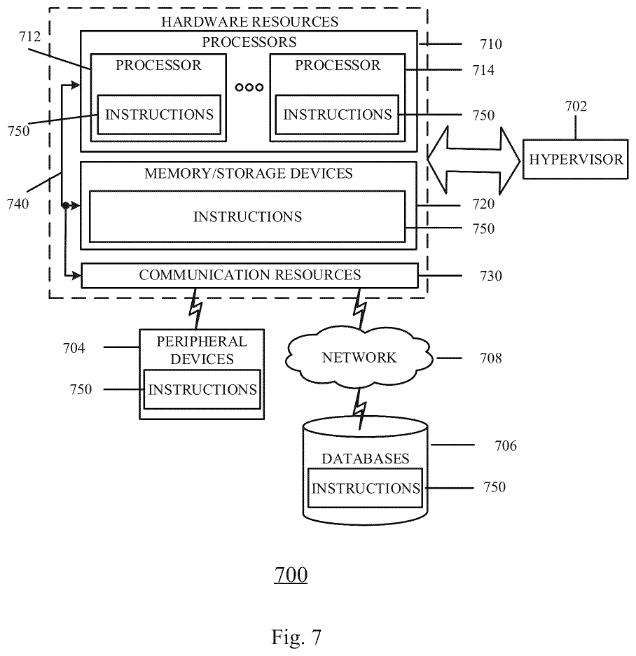

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714 which may be, e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

FIG. 8 is a block diagram of an example processor platform in accordance with some embodiments of the disclosure. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes interface circuitry 820. The interface circuitry 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuitry 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 820 of the illustrated example, thus, typically includes a graphics driver card, a graphics driver chip and/or a graphics driver processor.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 820 may include a training dataset inputted through the input device(s) 822 or retrieved from the network 826.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

Machine executable instructions 832 may be stored in the mass storage device 828, in the volatile memory 814, in the non-volatile memory 816, and/or on a removable non-transitory computer readable storage medium such as a CD or DVD.

The following paragraphs describe examples of various embodiments.

Example 1 includes an apparatus, comprising: interface circuitry configured to receive weight data and activation data, wherein the weight data and the activation data are stored in a batch-height-width-channel (NHWC) memory layout; and processor circuitry coupled to the interface circuitry and configured to: determine a process capacity of a process engine; determine an input channel size; in response to that the input channel size is not an integer multiple of the process capacity, pad a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine, slice all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and feed the process engine with each weight data slice and a corresponding activation data slice sequentially.

Example 2 includes the apparatus of Example 1, wherein a weight data slice comprises weight data elements from one or more data groups belonging to the filter, and each data group comprises weight data elements of the input channel size.

Example 3 includes the apparatus of Example 1 or 2, wherein the processor circuitry is further configured to perform the padding slicing, and feeding operations on weight data belonging to a next filter and corresponding activation data.

Example 4 includes the apparatus of any of Examples 1 to 3, wherein the process engine is neural network acceleration hardware and designed to calculate an inner product or convolution of data elements in the scale of the process capacity.

Example 5 includes the apparatus of any of Examples 1 to 4, wherein a memory utilization ratio

$$ratio = \frac{C\_size \times {W}_{k} \times {H}_{k} / PE\_capacity}{⌈ C\_size \times {W}_{k} \times {H}_{k} / PE\_capacity ⌉} ,$$

wherein C_size represents the input channel size, Wₖ represents the kernel width of the filter, Hₖ represents the kernel height of the filter, PE_capacity represents the process capacity of the process engine, and ┌⋅┐ means rounding up.

Example 5 includes the apparatus of any of Examples 1 to 5, wherein the process capacity of the process engine is 16, the input channel size is 8, and both the kernel width and the kernel height of the filter are 3, and the processor circuitry is configured to pad 8 zeroes after a last element of weight data belonging to the filter and a last element of corresponding activation data respectively; slice all 72 weight data elements belonging to the filter and 8 zeroes padded after the last element of the weight data into 5 weight data slices and corresponding 72 activation data elements and 8 zeroes padded after the last element of the corresponding activation data into corresponding 5 activation data slices, each of the 5 weight data slices and the corresponding 5 activation data slices comprising 16 data elements; and feed the process engine with each of the 5 weight data slices and a corresponding activation data slice sequentially in 5 computation cycles.

Example 7 includes the apparatus of Example 6, wherein a memory utilization ratio is 90%.

Example 8 includes the apparatus of any of Examples 1 to 5, wherein the process capacity of the process engine is 16, the input channel size is 24, and both the kernel width and the kernel height of the filter are 3, and the processor circuitry is configured to pad 8 zeroes after a last element of weight data belonging to the filter and a last element of corresponding activation data respectively; slice all 216 weight data elements belonging to the filter and 8 zeroes padded after the last element of the weight data into 14 weight data slices and corresponding 216 activation data elements and 8 zeroes padded after the last element of the corresponding activation data into corresponding 14 activation data slices, each of the 14 weight data slices and the corresponding 14 activation data slices comprising 16 data elements; and feed the process engine with each of the 14 weight data slices and a corresponding activation data slice sequentially in 14 computation cycles.

Example 9 includes the apparatus of Example 8, wherein a memory utilization ratio is 96.42%.

Example 10 includes a method, comprising: determining a process capacity of a process engine; determining an input channel size; in response to that the input channel size is not an integer multiple of the process capacity, padding a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine, wherein the weight data and the corresponding activation data are stored in a batch-height-width-channel (NHWC) memory layout, slicing all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and feeding the process engine with a weight data slice and a corresponding activation data slice sequentially.

Example 11 includes the method of Example 10, wherein a weight data slice comprises weight data elements from one or more data groups belonging to the filter, and each data group comprises weight data elements of the input channel size.

Example 12 includes the method of Example 10 or 11, further comprising: performing the padding slicing, and feeding operations on weight data belonging to a next filter and corresponding activation data.

Example 13 includes the method of any of Examples 10 to 12, wherein the process engine is neural network acceleration hardware and designed to calculate an inner product or convolution of data elements in the scale of the process capacity.

Example 14 includes the method of any of Examples 10 to 13, wherein a memory utilization

$$ratio = \frac{C\_size \times {W}_{k} \times {H}_{k} / PE\_capacity}{⌈ C\_size \times {W}_{k} \times {H}_{k} / PE\_capacity ⌉} ,$$

wherein C_size represents the input channel size, Wₖ represents the kernel width of the filter, Hₖ represents the kernel height of the filter, PE_capacity represents the process capacity of the process engine, and ┌⋅┐ means rounding up.

Example 15 includes the method of any of Examples 10 to 14, wherein the process capacity of the process engine is 16, the input channel size is 8, and both the kernel width and the kernel height of the filter are 3, and the method comprises padding 8 zeroes after a last element of weight data belonging to the filter and a last element of corresponding activation data respectively; slicing all 72 weight data elements belonging to the filter and 8 zeroes padded after the last element of the weight data into 5 weight data slices and corresponding 72 activation data elements and 8 zeroes padded after the last element of the corresponding activation data into corresponding 5 activation data slices, each of the 5 weight data slices and the corresponding 5 activation data slices comprising 16 data elements; and feeding the process engine with each of the 5 weight data slices and a corresponding activation data slice sequentially in 5 computation cycles.

Example 16 includes the method of Example 15, wherein a memory utilization ratio is 90%.

Example 17 includes the method of any of Examples 10 to 14, wherein the process capacity of the process engine is 16, the input channel size is 24, and both the kernel width and the kernel height of the filter are 3, and the method comprises padding 8 zeroes after a last element of weight data belonging to the filter and a last element of corresponding activation data respectively; slicing all 216 weight data elements belonging to the filter and 8 zeroes padded after the last element of the weight data into 14 weight data slices and corresponding 216 activation data elements and 8 zeroes padded after the last element of the corresponding activation data into corresponding 14 activation data slices, each of the 14 weight data slices and the corresponding 14 activation data slices comprising 16 data elements; and feeding the process engine with each of the 14 weight data slices and a corresponding activation data slice sequentially in 14 computation cycles.

Example 18 includes the method of Example 17, wherein a memory utilization ratio is 96.42%.

Example 19 includes a machine readable storage medium, having instructions stored thereon, which when executed by a machine, cause the machine to perform operations, comprising: determining a process capacity of a process engine; determining an input channel size; in response to that the input channel size is not an integer multiple of the process capacity, padding a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine, wherein the weight data and the corresponding activation data are stored in a batch-height-width-channel (NHWC) memory layout, slicing all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and feeding the process engine with a weight data slice and a corresponding activation data slice sequentially.

Example 20 includes the machine readable storage medium of Example 19, wherein a weight data slice comprises weight data elements from one or more data groups belonging to the filter, and each data group comprises weight data elements of the input channel size.

Example 21 includes the machine readable storage medium of Example 19 or 20, wherein the instructions when executed by the machine further cause the machine to perform the padding slicing, and feeding operations on weight data belonging to a next filter and corresponding activation data.

Example 22 includes the machine readable storage medium of any of Examples 19 to 21, wherein the process engine is neural network acceleration hardware and designed to calculate an inner product or convolution of data elements in the scale of the process capacity.

Example 23 includes the machine readable storage medium of any of Examples 19 to 22, wherein a memory utilization

$$ratio = \frac{C\_size \times {W}_{k} \times {H}_{k} / PE\_capacity}{⌈ C\_size \times {W}_{k} \times {H}_{k} / PE\_capacity ⌉} ,$$

wherein C_size represents the input channel size, Wₖ represents the kernel width of the filter, Hₖ represents the kernel height of the filter, PE_capacity represents the process capacity of the process engine, and ┌⋅┐ means rounding up.

Example 24 includes the machine readable storage medium of any of Examples 19 to 23, wherein the process capacity of the process engine is 16, the input channel size is 8, and both the kernel width and the kernel height of the filter are 3, and the instructions, when executed by the machine, cause the machine to pad 8 zeroes after a last element of weight data belonging to the filter and a last element of corresponding activation data respectively; slice all 72 weight data elements belonging to the filter and 8 zeroes padded after the last element of the weight data into 5 weight data slices and corresponding 72 activation data elements and 8 zeroes padded after the last element of the corresponding activation data into corresponding 5 activation data slices, each of the 5 weight data slices and the corresponding 5 activation data slices comprising 16 data elements; and feed the process engine with each of the 5 weight data slices and a corresponding activation data slice sequentially in 5 computation cycles.

Example 25 includes the machine readable storage medium of Example 24, wherein a memory utilization ratio is 90%.

Example 26 includes the machine readable storage medium of any of Examples 19 to 23, wherein the process capacity of the process engine is 16, the input channel size is 24, and both the kernel width and the kernel height of the filter are 3, and the instructions, when executed by the machine, cause the machine to pad 8 zeroes after a last element of weight data belonging to the filter and a last element of corresponding activation data respectively; slice all 216 weight data elements belonging to the filter and 8 zeroes padded after the last element of the weight data into 14 weight data slices and corresponding 216 activation data elements and 8 zeroes padded after the last element of the corresponding activation data into corresponding 14 activation data slices, each of the 14 weight data slices and the corresponding 14 activation data slices comprising 16 data elements; and feed the process engine with each of the 14 weight data slices and a corresponding activation data slice sequentially in 14 computation cycles.

Example 27 includes the machine readable storage medium of Example 26, wherein a memory utilization ratio is 96.42%.

Example 28 includes a device, comprising: means for determining a process capacity of a process engine; means for determining an input channel size; means for, in response to that the input channel size is not an integer multiple of the process capacity, padding a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine, wherein the weight data and the corresponding activation data are stored in a batch-height-width-channel (NHWC) memory layout, slicing all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and feeding the process engine with a weight data slice and a corresponding activation data slice sequentially.

Example 29 includes the device of Example 28, wherein a weight data slice comprises weight data elements from one or more data groups belonging to the filter, and each data group comprises weight data elements of the input channel size.

Example 30 includes the device of Example 28 or 29, further comprising: means for performing the padding slicing, and feeding operations on weight data belonging to a next filter and corresponding activation data.

Example 31 includes the device of any of Examples 28 to 30, wherein the process engine is neural network acceleration hardware and designed to calculate an inner product or convolution of data elements in the scale of the process capacity.

Example 32 includes the device of any of Examples 28 to 31, wherein a memory utilization

$$ratio = \frac{C\_size \times {W}_{k} \times {H}_{k} / PE\_capacity}{⌈ C\_size \times {W}_{k} \times {H}_{k} / PE\_capacity ⌉} ,$$

wherein C_size represents the input channel size, Wₖ represents the kernel width of the filter, Hₖ represents the kernel height of the filter, PE_capacity represents the process capacity of the process engine, and ┌⋅┐ means rounding up.

Example 33 includes the device of any of Examples 28 to 32, wherein the process capacity of the process engine is 16, the input channel size is 8, and both the kernel width and the kernel height of the filter are 3, and the device comprises means for padding 8 zeroes after a last element of weight data belonging to the filter and a last element of corresponding activation data respectively; means for slicing all 72 weight data elements belonging to the filter and 8 zeroes padded after the last element of the weight data into 5 weight data slices and corresponding 72 activation data elements and 8 zeroes padded after the last element of the corresponding activation data into corresponding 5 activation data slices, each of the 5 weight data slices and the corresponding 5 activation data slices comprising 16 data elements; and means for feeding the process engine with each of the 5 weight data slices and a corresponding activation data slice sequentially in 5 computation cycles.

Example 34 includes the device of Example 33, wherein a memory utilization ratio is 90%.

Example 35 includes the device of any of Examples 28 to 32, wherein the process capacity of the process engine is 16, the input channel size is 24, and both the kernel width and the kernel height of the filter are 3, and the device comprises means for padding 8 zeroes after a last element of weight data belonging to the filter and a last element of corresponding activation data respectively; means for slicing all 216 weight data elements belonging to the filter and 8 zeroes padded after the last element of the weight data into 14 weight data slices and corresponding 216 activation data elements and 8 zeroes padded after the last element of the corresponding activation data into corresponding 14 activation data slices, each of the 14 weight data slices and the corresponding 14 activation data slices comprising 16 data elements; and means for feeding the process engine with each of the 14 weight data slices and a corresponding activation data slice sequentially in 14 computation cycles.

Example 36 includes the device of Example 35, wherein a memory utilization ratio is 96.42%.

Example 37 includes a computer program product, having programs to perform the method of any of Examples 10 to 18.

Example 38 includes an apparatus as shown and described in the description.

Example 39 includes a method performed at an apparatus as shown and described in the description.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. The disclosure is intended to cover any adaptations or variations of the embodiments discussed herein. Therefore, it is manifestly intended that embodiments described herein be limited only by the appended claims and the equivalents thereof.

1. An apparatus, comprising:
interface circuitry to receive weight data and activation data, the weight data and the activation data are stored in a batch-height-width-channel (NHWC) memory layout;
instructions; and
processor circuitry to execute the instructions to:
determine a process capacity of a process engine;
determine an input channel size;
in response to the input channel size not being an integer multiple of the process capacity,
pad a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine,
slice all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and
feed the process engine with each weight data slice and a corresponding activation data slice sequentially.

2. The apparatus of claim 1, wherein a weight data slice comprises weight data elements from one or more data groups belonging to the filter, and each data group comprises weight data elements of the input channel size.

3. The apparatus of claim 1, wherein the processor circuitry is to perform the padding slicing, and feeding operations on weight data belonging to a next filter and corresponding activation data.

4. The apparatus of claim 1, wherein the process engine is neural network acceleration hardware, the neural network acceleration hardware to calculate an inner product or convolution of data elements in the scale of the process capacity.

5. The apparatus of claim 1, wherein the process capacity of the process engine is 16, the input channel size is 8, and both the kernel width and the kernel height of the filter are 3, and the processor circuitry is to:
pad 8 zeroes after a last element of weight data belonging to the filter and a last element of corresponding activation data respectively;
slice all 72 weight data elements belonging to the filter and 8 zeroes padded after the last element of the weight data into 5 weight data slices and corresponding 72 activation data elements and 8 zeroes padded after the last element of the corresponding activation data into corresponding 5 activation data slices, each of the 5 weight data slices and the corresponding 5 activation data slices comprising 16 data elements; and
feed the process engine with each of the 5 weight data slices and a corresponding activation data slice sequentially in 5 computation cycles.

6. The apparatus of claim 5, wherein a memory utilization ratio is 90%.

7. The apparatus of claim 1, wherein the process capacity of the process engine is 16, the input channel size is 24, and both the kernel width and the kernel height of the filter are 3, and the processor circuitry is to:
pad 8 zeroes after a last element of weight data belonging to the filter and a last element of corresponding activation data respectively;
slice all 216 weight data elements belonging to the filter and 8 zeroes padded after the last element of the weight data into 14 weight data slices and corresponding 216 activation data elements and 8 zeroes padded after the last element of the corresponding activation data into corresponding 14 activation data slices, each of the 14 weight data slices and the corresponding 14 activation data slices comprising 16 data elements; and
feed the process engine with each of the 14 weight data slices and a corresponding activation data slice sequentially in 14 computation cycles.

8. The apparatus of claim 7, wherein a memory utilization ratio is 96.42%.

9. A method, comprising:
determining a process capacity of a process engine;
determining an input channel size;
in response to the input channel size not being an integer multiple of the process capacity,
padding a number of zeroes after a last element of weight data belonging to a filter and a last element of corresponding activation data respectively, wherein the number equals to an absolute difference between the process capacity of process engine and a remainder of a product of the input channel size and a kernel width and a kernel height of the filter divided by the process capacity of process engine, wherein the weight data and the corresponding activation data are stored in a batch-height-width-channel (NHWC) memory layout,
slicing all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and
feeding the process engine with a weight data slice and a corresponding activation data slice sequentially.

10. The method of claim 9, wherein a weight data slice comprises weight data elements from one or more data groups belonging to the filter, and each data group comprises weight data elements of the input channel size.

11. The method of claim 9, further comprising:
performing the padding slicing, and feeding operations on weight data belonging to a next filter and corresponding activation data.

12. The method of claim 9, wherein the process engine is neural network acceleration hardware, the process engine to calculate an inner product or convolution of data elements in the scale of the process capacity.

13. The method of claim 9, wherein the process capacity of the process engine is 16, the input channel size is 8, and both the kernel width and the kernel height of the filter are 3, and the method comprises:
padding 8 zeroes after a last element of weight data belonging to the filter and a last element of corresponding activation data respectively;
slicing all 72 weight data elements belonging to the filter and 8 zeroes padded after the last element of the weight data into 5 weight data slices and corresponding 72 activation data elements and 8 zeroes padded after the last element of the corresponding activation data into corresponding 5 activation data slices, each of the 5 weight data slices and the corresponding 5 activation data slices comprising 16 data elements; and
feeding the process engine with each of the 5 weight data slices and a corresponding activation data slice sequentially in 5 computation cycles.

14. (canceled)

15. The method of claim 9, wherein the process capacity of the process engine is 16, the input channel size is 24, and both the kernel width and the kernel height of the filter are 3, and the method comprises:
padding 8 zeroes after a last element of weight data belonging to the filter and a last element of corresponding activation data respectively;
slicing all 216 weight data elements belonging to the filter and 8 zeroes padded after the last element of the weight data into 14 weight data slices and corresponding 216 activation data elements and 8 zeroes padded after the last element of the corresponding activation data into corresponding 14 activation data slices, each of the 14 weight data slices and the corresponding 14 activation data slices comprising 16 data elements; and
feeding the process engine with each of the 14 weight data slices and a corresponding activation data slice sequentially in 14 computation cycles.

16. (canceled)

17. A memory comprising instructions to cause a machine to:
determine a process capacity of a process engine;
determine an input channel size;
in response to the input channel size not being an integer multiple of the process capacity,
pad a number of zeroes after a last element of weight data belonging to a filter and a last element of corresponding activation data respectively, the number equals an absolute difference between the process capacity of the process engine and a remainder of a product of the input channel size and a kernel width and a kernel height of the filter divided by the process capacity of the process engine, the weight data and the corresponding activation data are stored in a batch-height-width-channel (NHWC) memory layout,
slice all weight data elements belonging to the filter and zeroes padded after the last element of the weight data into weight data slices in a scale of the process capacity, and corresponding activation data elements and zeroes padded after the last element of the corresponding activation data into corresponding activation data slices in the scale of the process capacity, and
feed the process engine with a weight data slice and a corresponding activation data slice sequentially.

18. The machine readable storage medium of claim 17, wherein a weight data slice comprises weight data elements from one or more data groups belonging to the filter, and each data group comprises weight data elements of the input channel size.

19. The machine readable storage medium of claim 17, wherein the instructions cause the machine to pad, slice and feed weight data belonging to a next filter and corresponding activation data.

20. The machine readable storage medium of claim 17, wherein the process engine is neural network acceleration hardware, the process engine to calculate an inner product or convolution of data elements in the scale of the process capacity.

21. The machine readable storage medium of claim 17, wherein the process capacity of the process engine is 16, the input channel size is 8, and both the kernel width and the kernel height of the filter are 3, and the instructions, when executed by the machine, cause the machine to:
pad 8 zeroes after a last element of weight data belonging to the filter and a last element of corresponding activation data respectively;
slice all 72 weight data elements belonging to the filter and 8 zeroes padded after the last element of the weight data into 5 weight data slices and corresponding 72 activation data elements and 8 zeroes padded after the last element of the corresponding activation data into corresponding 5 activation data slices, each of the 5 weight data slices and the corresponding 5 activation data slices comprising 16 data elements; and
feed the process engine with each of the 5 weight data slices and a corresponding activation data slice sequentially in 5 computation cycles.

22. (canceled)

23. The machine readable storage medium of claim 17, wherein the process capacity of the process engine is 16, the input channel size is 24, and both the kernel width and the kernel height of the filter are 3, and the instructions, when executed by the machine, cause the machine to:
pad 8 zeroes after a last element of weight data belonging to the filter and a last element of corresponding activation data respectively;
slice all 216 weight data elements belonging to the filter and 8 zeroes padded after the last element of the weight data into 14 weight data slices and corresponding 216 activation data elements and 8 zeroes padded after the last element of the corresponding activation data into corresponding 14 activation data slices, each of the 14 weight data slices and the corresponding 14 activation data slices comprising 16 data elements; and
feed the process engine with each of the 14 weight data slices and a corresponding activation data slice sequentially in 14 computation cycles.

24. (canceled)

25. (canceled)
